(19) United States
(12) Patent Application Publication
(10) Pub. No.: US 2013/0122230 A1
(43) Pub. Date: May 16, 2013

(54) PHOSPHOR-CONTAINING COMPOSITE MATERIAL

(71) Applicants: Yu-Ting Tsai, Tainan City (TW); Yi-Chang Tseng, Tainan City (TW); Chia-Rong Chuang, Tainan City (TW); Chun-Yu Wu, Tainan City (TW)

(72) Inventors: Yu-Ting Tsai, Tainan City (TW); Yi-Chang Tseng, Tainan City (TW); Chia-Rong Chuang, Tainan City (TW); Chun-Yu Wu, Tainan City (TW)

(73) Assignee: JOHNPHIL TECHNOLOGY CORP., Tainan City (TW)

(21) Appl. No.: 13/463,925

(22) Filed: May 4, 2012

(30) Foreign Application Priority Data
May 4, 2011 (TW) 100207910

(51) Int. Cl. C09K 11/02; B32B 7/06; B32B 7/12; C09J 7/02

(52) U.S. Cl. CPC C09K 11/025; C09J 7/0264; B32B 7/06; B32B 7/12
USPC 428/40.1; 428/343; 428/355 RA

(57) ABSTRACT

A phosphor-containing composite material comprises: an optical excitable film including a releasable adhesive matrix and a phosphor dispersed in the releasable adhesive matrix, the optical excitable film having a surface and a peel adhesion value ranging from 10-200 g/inch as determined by PSTC-1 standard test; and a plastic substrate bonded peelably and directly to the surface of the optical excitable film.

### CROSS-REFERENCE TO RELATED APPLICATION

This application claims priority of Taiwanese application no. 100207910, filed on May 4, 2011.

### BACKGROUND OF THE INVENTION

1. Field of the invention

The invention relates to a phosphor-containing composite material, and more particularly to a phosphor-containing composite material including an optical excitable film and a plastic substrate bonded releasably and directly to the optical excitable film.

2. Description of the related art

U.S. Pat. No. 7,294,861 discloses a phosphor tape article that includes a phosphor layer and a pressure sensitive adhesive (PSA) layer. The phosphor tape article can optionally include one or more substrate layers interposed between the phosphor layer and the PSA layer, and a liner releasably attached to the PSA layer. The phosphor layer includes a phosphor and a polymeric binder material. The polymeric binder material can be polymers, copolymers and oligomers, such as fluoropolymers, polyarylates, polycarbonates, polyimides, epoxies, and silicones. The PSA layer can be made from polymers, such as rubber-based polymers, silicone elastomer-based polymers, poly-α-olefin-based polymers, and (meth)-acrylate-based polymers. The PSA layer provides the phosphor tape article with a peelable bonding strength so that the phosphor layer of the phosphor tape article can be attached a light emitting device, such as an encapsulated LED, for converting a light from the LED into a desired color. Since the phosphor tape article requires the PSA layer for providing adhering function, the manufacturing cost thereof is increased. In addition, the inclusion of the PSA layer in the phosphor tape article can undesirably absorb the light emitted from the LED and the light converted by the phosphor layer.

### SUMMARY OF THE INVENTION

Therefore, the object of the present invention is to provide a phosphor-containing composite material that can overcome the aforesaid drawbacks associated with the prior art.

According to the present invention, there is provided a phosphor-containing composite material that comprises: an optical excitable film including a releasable adhesive matrix and a phosphor dispersed in the releasable adhesive matrix, the optical excitable film having a surface and a peel adhesion value ranging from 10-200 g/inch as determined by PSTC-1 standard test; and a plastic substrate bonded peelably and directly to the surface of the optical excitable film.

### BRIEF DESCRIPTION OF THE DRAWINGS

In drawings which illustrate an embodiment of the invention,

FIG. 1 is a schematic view of the preferred embodiment of a phosphor-containing composite material according to the present invention;

FIG. 2 is a fragmentary partly sectional view of a light emitting device including the preferred embodiment;

FIG. 3 is a fragmentary partly sectional view of a modified light emitting device modified from light emitting device of FIG. 2; and

FIG. 4 is a schematic view of a lamp device including the preferred embodiment.

### DETAILED DESCRIPTION OF THE PREFERRED EMBODIMENT

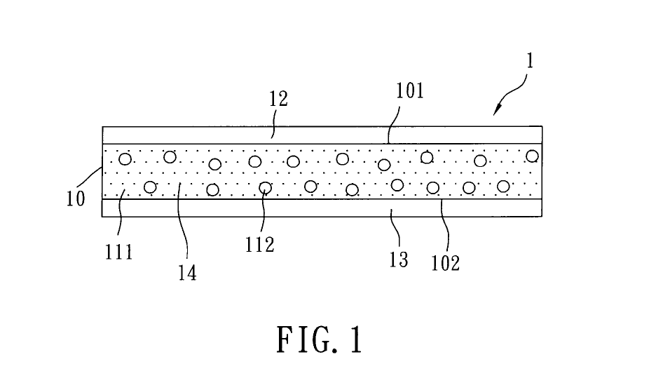

FIG. 1 illustrates the preferred embodiment of a phosphor-containing composite material 1 according to the present invention. The phosphor-containing composite material 1 can be applied to a light source, such as LEDs and lamp devices.

The phosphor-containing composite material 1 includes: an optical excitable film 10 having a releasable adhesive matrix 111 and a phosphor 112 dispersed uniformly in the releasable adhesive matrix 111, the optical excitable film 10 having first and second surfaces 101, 102 that are opposite to each other and a peel adhesion value ranging from 10-200 g/inch as determined by PSTC-1 (Pressure Sensitive Tape Council, 180° peel resistance test) standard test; a first plastic substrate 12 bonded peelably and directly to the first surface 101 of the optical excitable film 10; and a second plastic substrate 13 bonded peelably and directly to the second surface 102 of the optical excitable film 10.

When the peel adhesion value of the optical excitable film 10 is less than 10 g/inch, the adhesiveness of the optical excitable film 10 is insufficient for bonding to an object (not shown). When the peel adhesion value of the optical excitable film 10 is higher than 200 g/inch, the adhesiveness of the optical excitable film 10 is too strong that the first and second plastic substrates 12, 13 cannot be easily released therefrom.

Preferably, the releasable adhesive matrix 111 is made from an adhesive material containing a tacky polymer selected from polyacrylic acid resins, polyacrylate resins, polyisocynate resins, and epoxy resins.

The adhesive material can further contain a crosslinking agent selected from epoxy compounds, isocynate compounds and silane-containing compounds. Preferably, the crosslinking agent is in an amount ranging from 1-5 parts by weight per 100 parts by weight of the releasable adhesive matrix 111.

Preferably, the adhesive material is prepared from a slurry containing the tacky polymer and a solvent for dissolving the tacky polymer. The slurry preferably has a viscosity ranging from 500-20000 cps at 25° C., and a solid content ranging from 25-65 wt %. After the slurry is applied to the first plastic substrate 12, the solvent is removed from the slurry by heating so as to form the releasable adhesive matrix 111 on the first plastic substrate 12.

Preferably, the first plastic substrate 12 is made from a non-tacky polymer selected from polycarbonate, polyimide, polyethersulfone, polyacrylate, polyethylene, polyethylene terephthalate, polyetheretherketone, polyethylene naphthalate, and polyetherimide. The second plastic substrate 13 can be made from a polymer the same as that of the first plastic substrate 12.

Examples of the phosphor 112 employed in the optical excitable film 10 may be those disclosed in the U.S. Pat. No. 7,294,861.

The optic-excitable film 10 can optionally include a plurality of quantum dots 14 dispersed in the releasable adhesive matrix 111 for enhancing the brightness of the light converted by the phosphor 112. Preferably, the weight ratio of the quantum dots 14 to the combination of the releasable adhesive matrix 111 and the phosphor 112 ranges from 0.001-0.002.

Preferably, the optical excitable film 10 includes 1-35 parts by weight of the phosphor 112 per 100 parts by weight of the releasable adhesive matrix 111. When the phosphor 112 is in an amount less than 1 part per 100 parts by weight of the releasable adhesive matrix 111, the optical excitable film 10 cannot effectively convert the light from a light source into a desired color. When the phosphor 112 is in an amount higher than 35 part per 100 parts by weight of the releasable adhesive matrix 111, non-uniform dispersion of the phosphor 112 in the releasable adhesive matrix 111 can occur and the tackiness of the releasable adhesive matrix 111 can be considerably reduced.

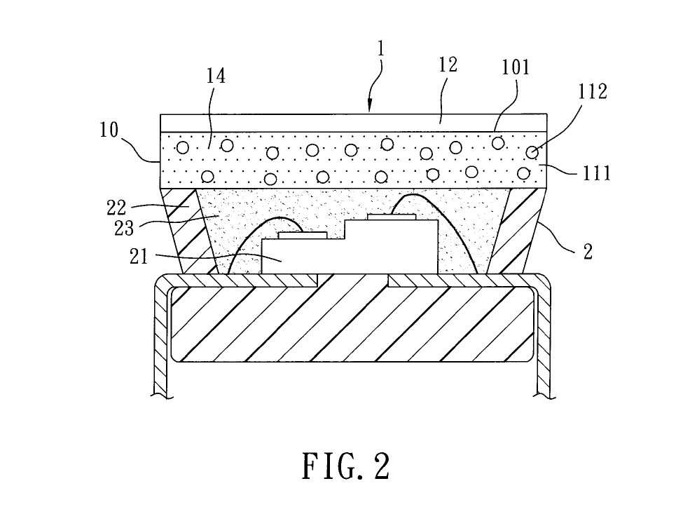

FIG. 2, in combination with FIG. 1, illustrates an application of the phosphor-containing composite material 1 to an LED package 2 to form an LED device. The LED package 2 includes an LED chip 21 mounted in a cup 22 that is filled with an encapsulant 23. In this application, the second plastic substrate 13 is peeled off from the phosphor-containing composite material 1 to permit the optic-excitable film 10 to be directly bonded to a top of the cup 22 and a top surface of the encapsulant 23.

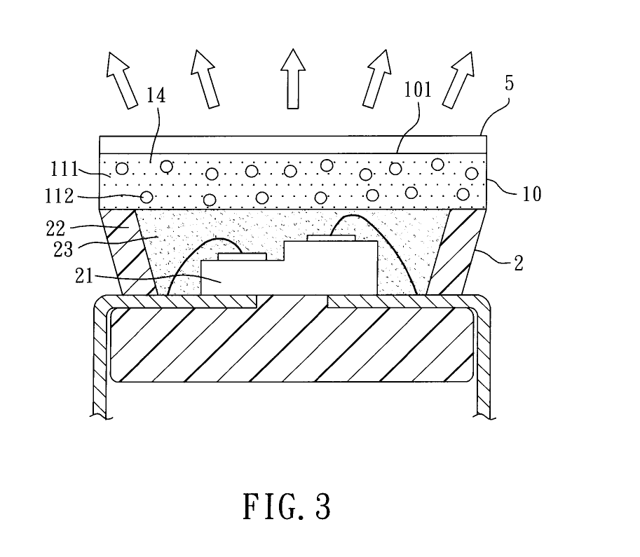

FIG. 3 illustrates a modified LED device modified from the LED device of FIG. 2 by replacing the first plastic substrate 12 with an optical element 5, such as a light guide plate, a diffuser plate, a reflector plate, a lens, and the like.

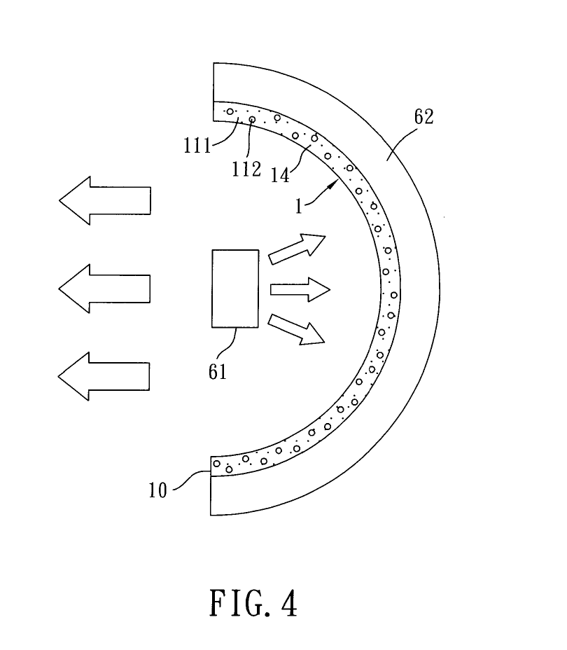

FIG. 4, in combination with FIG. 1, illustrates another application of the phosphor-containing composite material 1 to a lamp device. The lamp device includes a light source 61 and an arc-shaped reflector 62. In this application, the first and second plastic substrates 12, 13 are peeled off from the phosphor-containing composite material 1 to permit the optic-excitable film 10 to be directly bonded to an inner surface of the arc-shaped reflector 62.

By dispersing the phosphor 112 into the releasable adhesive matrix 111 of the phosphor-containing composite material 1 of this invention, the optical excitable film 10 is capable of proving a light conversion function and an adhering function and the aforesaid drawbacks associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A phosphor-containing composite material comprising:
an optical excitable film including a releasable adhesive matrix and a phosphor dispersed in the releasable adhesive matrix, said optical excitable film having a first surface and a peel adhesion value ranging from 10-200 g/inch as determined by PSTC-1 standard test; and
a first plastic substrate bonded peelably and directly to said first surface of said optical excitable film.

2. The phosphor-containing composite material of claim 1, wherein said releasable adhesive matrix is made from an adhesive material containing a tacky polymer selected from polyacrylic acid resins, polyacrylate resins, polyisocynate resins, and epoxy resins.

3. The phosphor-containing composite material of claim 1, wherein said first plastic substrate is made from a non-tacky polymer selected from polycarbonate, polyimide, polyethersulfone, polyacrylate, polyethylene, polyethylene terephthalate, polyetheretherketone, polyethylene naphthalate, and polyetherimide.

4. The phosphor-containing composite material of claim 1, further comprising a second plastic substrate, said optical excitable film further having a second surface opposite to said first surface, said second plastic substrate being peelably bonded to said second surface of said optical excitable film.

5. The phosphor-containing composite material of claim 2, wherein said adhesive material further contains a crosslinking agent selected from epoxy compounds, isocynate compounds and silane-containing compounds.

6. The phosphor-containing composite material of claim 1, wherein said optic-excitable film further includes a plurality of quantum dots dispersed in said releasable adhesive matrix.

7. The phosphor-containing composite material of claim 1, wherein said optical excitable film includes 1-35 parts by weight of said phosphor per 100 parts by weight of said releasable adhesive matrix.
